(19) United States
(12) Patent Application Publication
(10) Pub. No.: US 2003/0067105 A1
(43) Pub. Date: Apr. 10, 2003

(54) Chopping board device and storage box for receiving chopping boards

(76) Inventor: Jen-Fu Chen, Feng Yuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/972,889

(22) Filed: Oct. 10, 2001

(51) Int. Cl. B23Q 3/00

(52) U.S. Cl. 269/289 R

(57) ABSTRACT

A chopping board device comprises a base comprising a receiving space and a chopping board removably received in the receiving space. The chopping board device may further comprise at least one spare receiving space for receiving at least one spare chopping board. In addition, a storage box may be provided for receiving spare chopping boards.

### BACKGROUND OF THE INVENTION

1. Field of the Invention

The present invention relates to a chopping board device and a storage box for receiving chopping boards. In particular, the present invention relates to a chopping board device in which a chopping board is removably received such that the chopping board, when becoming discardable, may be readily replaced by a new one. The present invention also relates to a storage box for receiving spare chopping boards.

2. Description of the Related Art

Wooden chopping boards have gradually been replaced by plastic ones, as it becomes more and more difficult to find suitable material for the former. FIG. 1 of the drawings illustrates a typical plastic chopping board that can be manufactured easily by choosing suitable plastic material and forming a board by injection molding. Regardless of the material, a chopping board must be discarded once a recess with a considerable depth is defined in a surface thereof as a result of chopping, as the recess may receive dirty material that would contaminate food on the chopping board. And the recess is apt to be formed on the chopping board, as the user often has to apply a relatively large force to chop stiff food, particularly frozen food that is not de-frozen properly, such as chicken, pork, etc. A typical chopping board has a thickness of about 1 cm, and it is a waste and results in an additional trash if the chopping board is discarded just because there is a recess having a depth of 1 mm in the surface.

### SUMMARY OF THE INVENTION

An object of the present invention is to provide a chopping board device in which a chopping board is removably received such that the chopping board, when becoming discardable for sanitary or other purpose, may be readily replaced by a new one.

Another object of the present invention is to provide a chopping board device that receives spare chopping boards.

A further object of the present invention is to provide a storage box for receiving spare chopping boards and/or used chopping boards.

A chopping board device in accordance with the present invention comprises a base comprising a receiving space and a chopping board removably received in the receiving space.

The chopping board device may further comprise at least one spare receiving space for receiving at least one spare chopping board. In addition, a storage box may be provided for receiving spare chopping boards.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a conventional chopping board.

FIG. 2 is a perspective chopping board device in accordance with the present invention.

FIG. 3 is an exploded perspective view of the chopping board device in accordance with the present invention.

FIG. 4 is a perspective view of a modified embodiment of the chopping board device in accordance with the present invention.

FIG. 5 is a perspective view of a storage box for receiving spare chopping board. FIG. 6 is a perspective view illustrating use of the storage box and another modified embodiment of the chopping board device in accordance with the present invention.

FIG. 7 is a perspective view of the chopping board device in FIG. 6.

FIG. 8 is a perspective view, partly exploded, illustrating a further embodiment of the chopping board device in accordance with the present invention.

FIG. 9 is a sectional view taken along plane A-A in FIG. 8 and in an enlarged scale, wherein the chopping board is not yet retained in place.

FIG. 10 is a sectional view taken along plane A-A in FIG. 8 and in an enlarged scale, wherein the chopping board is yet retained in place.

FIG. 11 is a perspective view of a further embodiment of the chopping board device in accordance with the present invention.

FIG. 12 is a perspective view of another embodiment of the storage box in accordance with the present invention.

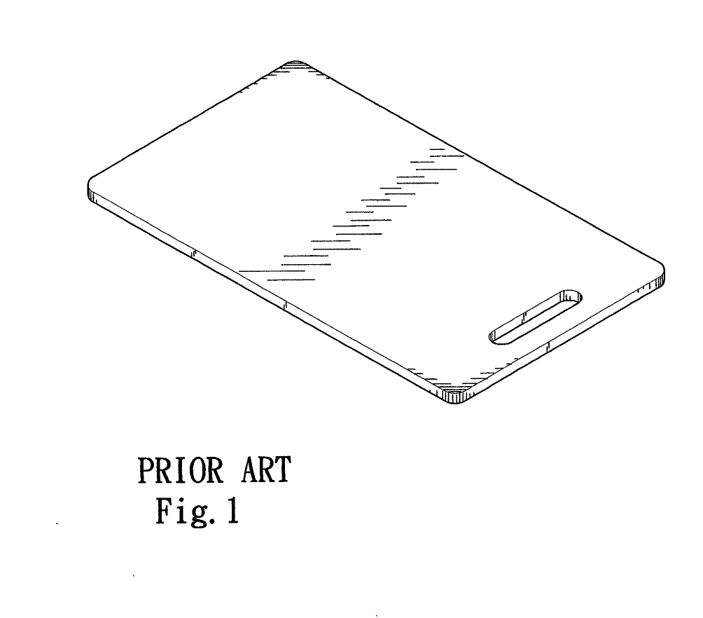

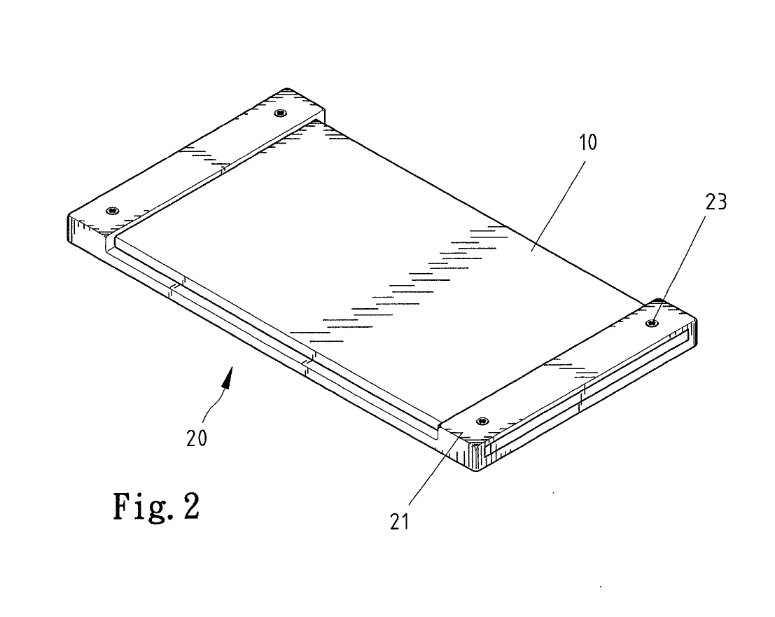

### DETAILED DESCRIPTION OF THE PREFERRED EMBODIMENTS

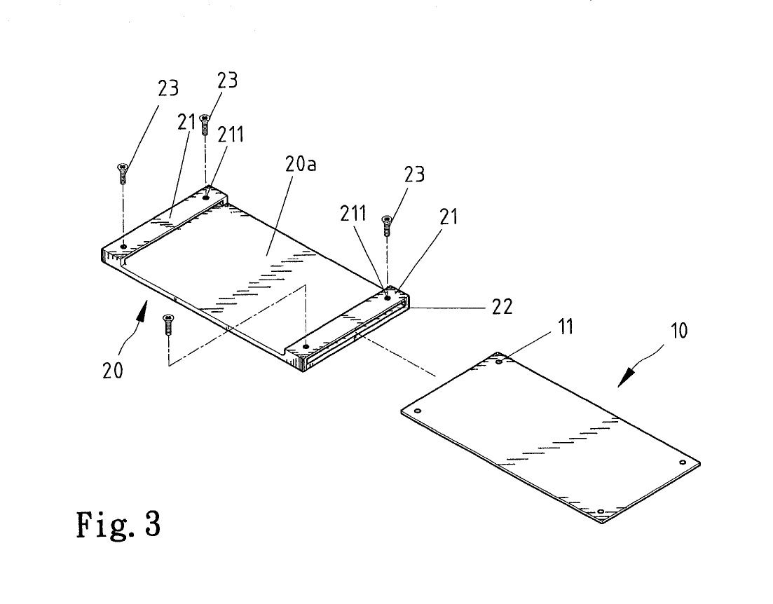

Referring to FIGS. 2 and 3, an embodiment of a chopping board device in accordance with the present invention generally comprises a base 20 having an inverted U-shape frame 21 on a side thereof, thereby defining a retaining slot 22 between the inverted U-shaped frame 21 and the side of the base 20. A chopping board 10 is inserted through the retaining slot 22 along a longitudinal direction of the base 20 into a receiving space 20a defined by the base 20. The retaining slot 22 is a portion of the receiving space 20a that is formed above the base 20. An end of the chopping board 10 is received in the retaining slot 22 after the chopping board 10 is inserted into the receiving space 20a of the base 20. Another inverted U-shape frame 21 is provided on the other side of the base 20 for receiving the other end of the chopping board 10. Screws 23 are extended through holes 211 in each frame 21 and hole 11 in each end of the chopping board 10 to thereby secure the chopping board 10 in place. The inverted U-shaped frame 21 on the other side of the base 20 may define another slot (not shown) to allow optional insertion of the chopping board 10 into the receiving space 20a of the base 20 via either slot. Of course, the chopping board 10 can be easily removed from the base 20 when it has to be discarded due to as being broken or under sanitary consideration. In order to save cost, the chopping board 10 in accordance with the present invention may be thinner than conventional ones. For example, the chopping board 10 in accordance with the present invention may have a thickness that is a half of that of a conventional chopping board. Thus, the cost is saved, as less material is used.

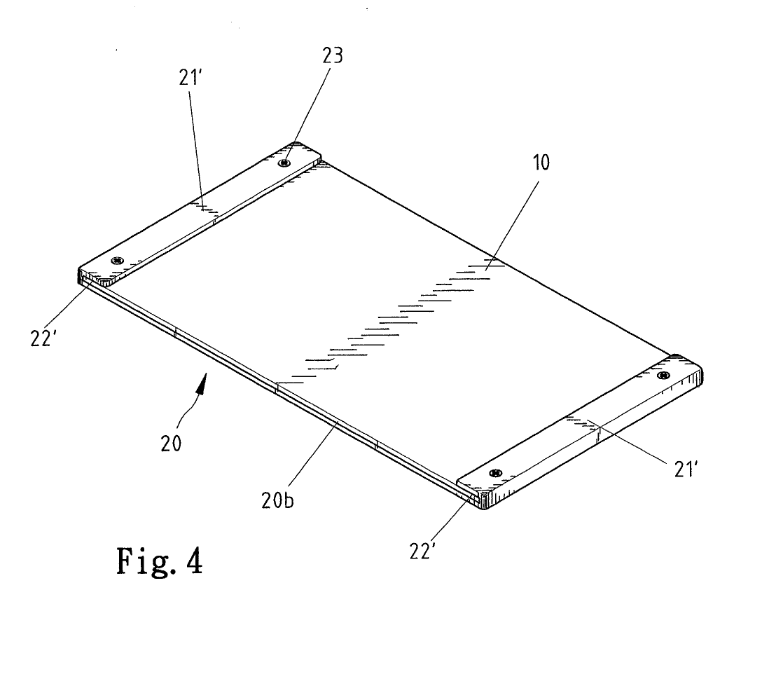

FIG. 4 illustrates a modified embodiment of the chopping board device, wherein the base 20 comprises an L-shaped frame 21′ extending from each end thereof to thereby define a retaining slot 22′. Thus, a chopping board 10 may be inserted into the receiving space 20b of the base 20 from a direction transverse to the longitudinal direction of the base 20. Similarly, screws 23 are used to fasten the chopping board 10 in place.

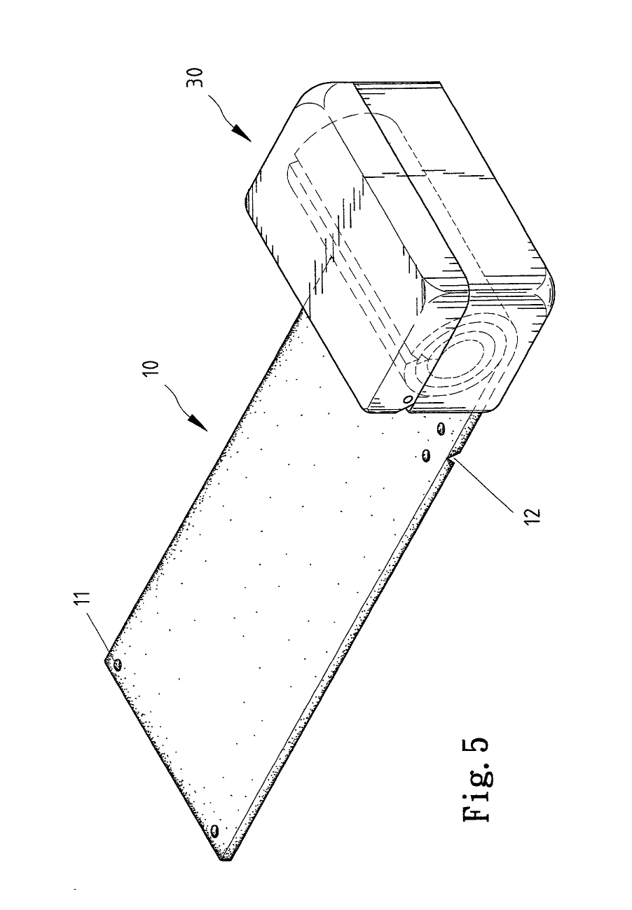

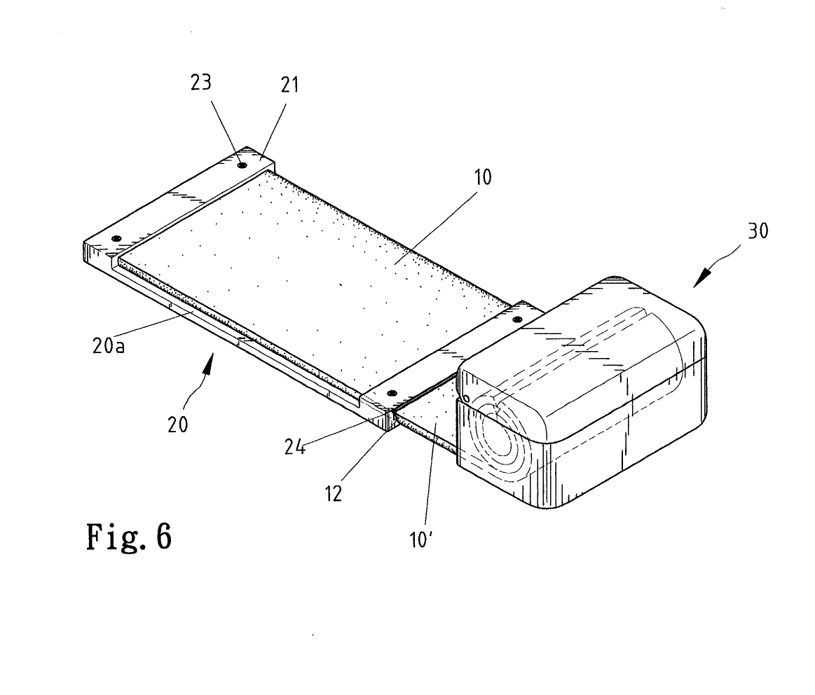

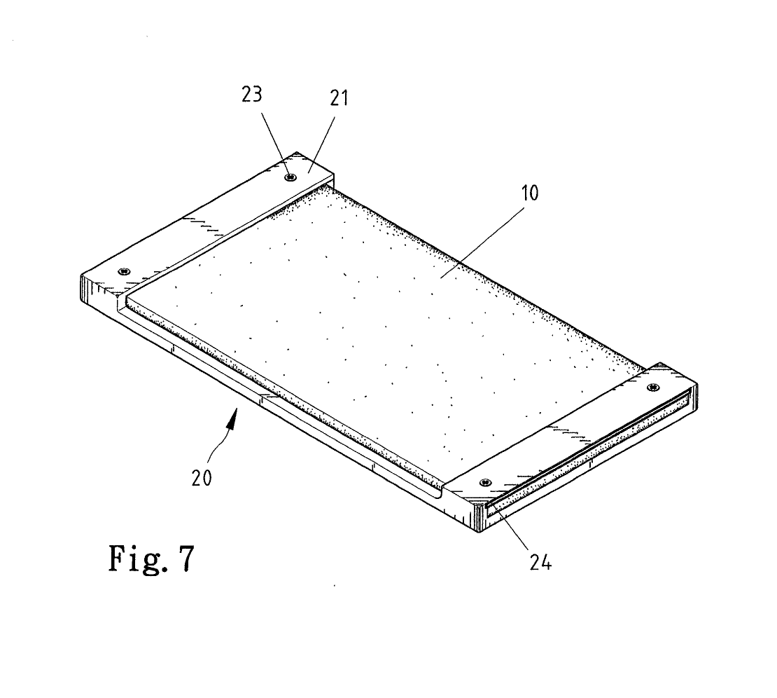

FIG. 5 illustrates a storage box 30 for receiving coiled continuous spare chopping boards 10. A severing notch 12 is defined between two chopping boards 10 adjacent to each other and extending along a width direction of the chopping boards 10. Referring to FIG. 6, after inserting the outermost chopping board 10 into the receiving space 20a of the base 20 and fastening the chopping board 10 in place by screws 23, the outermost chopping board 10 may be separated from the remaining chopping board 10′ by a severing means 24 provided to an edge of the frame 21. The chopping board device is now ready for use, as shown in FIG. 7. The storage box 30 provides a convenient storage of spare chopping boards 10′ without the risk of being contaminated.

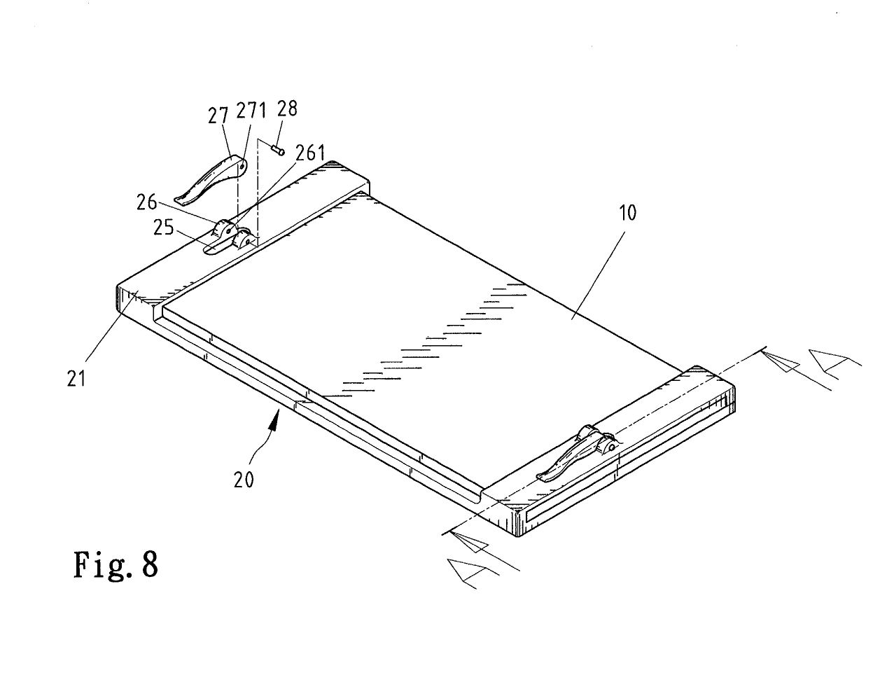

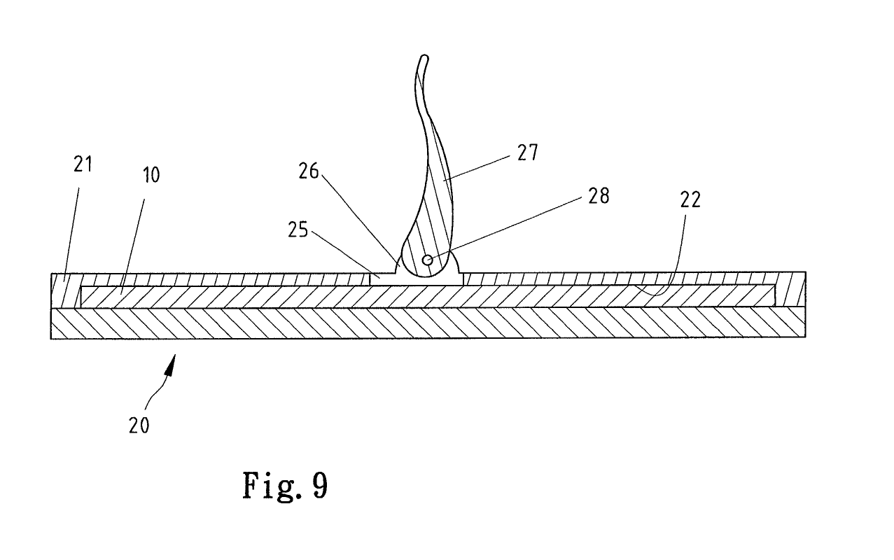

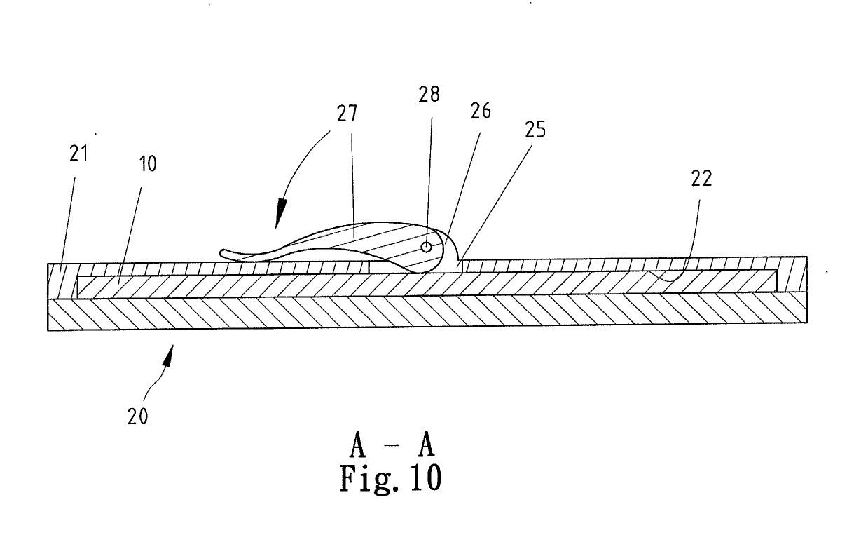

FIG. 8 illustrates a further modified embodiment of the chopping board device, wherein each frame 21 has an opening 25 communicated with the retaining slot 22 and two lugs 26 located on both sides of the opening 25. A lever 27 has an end pivoted between the lugs 26 by means of extending a pin 28 through aligned holes 261 in the lugs 26 and an eccentric pin hole 271 in the end of the lever 27. Referring to FIG. 9, when the lever 27 is in a release position shown in FIG. 9, the chopping board 10 is not retained in place. When the lever 27 is in a retaining position shown in FIG. 10, the chopping board 10 is retained in place by the end of the lever 27 that is moved through the opening 25 to a position pressing against an upper face of the chopping board 10. This retaining effect is owing to the configuration of the end of the lever 27 and the eccentric pin hole 271.

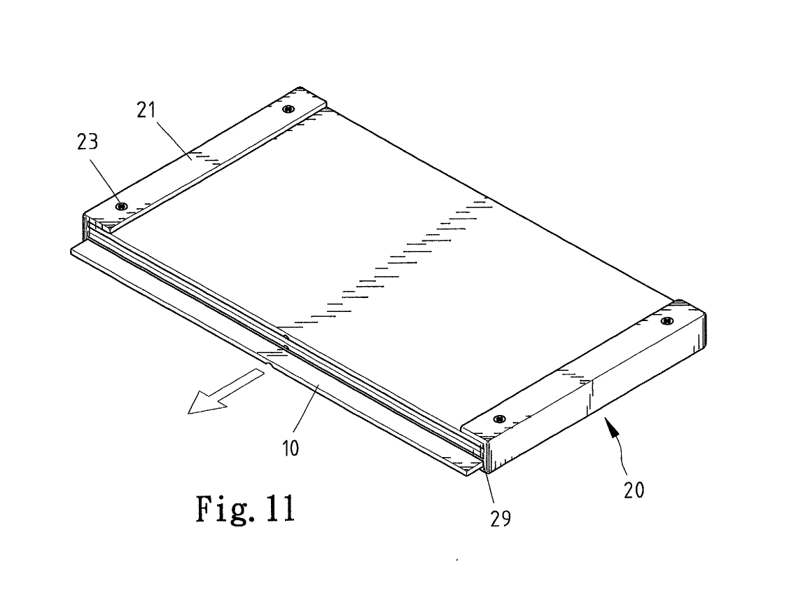

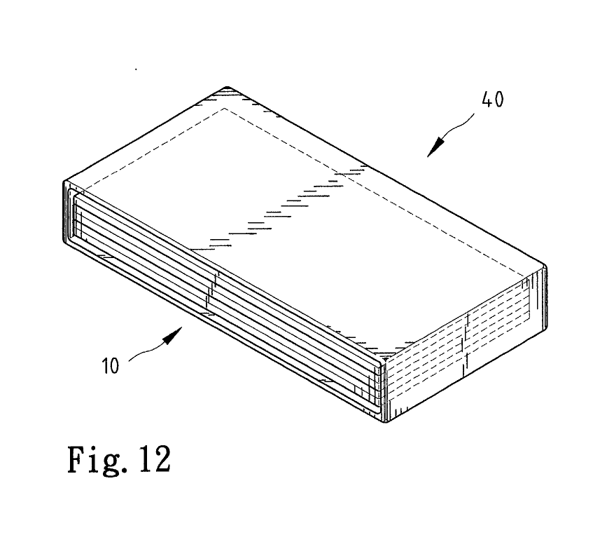

FIG. 11 illustrates another modified embodiment of the invention, wherein the base comprises at least one spare receiving space 29 for receiving at least one spare chopping board 10. Of course, the old chopping board 10 to be discarded after replacement can be received in the spare receiving space 29. The overall strength of the chopping board device will not be adversely affected. FIG. 12 illustrates a modified embodiment of the storage box that is in the form of a simple box 40 for receiving spare chopping boards 10 and/or used chopping boards 10 to be discarded.

Although the invention has been explained in relation to its preferred embodiment, it is to be understood that many other possible modifications and variations can be made without departing from the scope of the invention as hereinafter claimed.

What is claimed is:

1. A chopping board device comprising:
a base comprising a receiving space; and
a chopping board removably received in the receiving space.

2. The chopping board device as claimed in claim 1, further comprising at least one spare receiving space for receiving at least one spare chopping board.

3. The chopping board device as claimed in claim 1, further comprising a storage box for receiving spare chopping boards.

4. The chopping board device as claimed in claim 1, wherein the spare chopping boards are in a continuous form and coiled in the storage box, a notch being defined between two of the chopping boards that are adjacent to each other and extending along a width direction of the chopping boards, the notch allowing easy separation of said two chopping boards that are adjacent to each other.

5. The chopping board device as claimed in claim 4, wherein the base further comprising a severing means for separation said two chopping boards that are adjacent to each other by means of severing along the notch.

6. The chopping board device as claimed in claim 1, wherein the base comprises an inverted U-shaped frame in each of two sides thereof, a retaining slot being defined between each of the inverted U-shaped frames and an associated one of the sides of the base, thereby allowing insertion of the chopping board into the receiving space along a longitudinal direction of the base.

7. The chopping board device as claimed in claim 6, wherein the chopping board comprises at least one first hole in each of two ends thereof, each of the inverted U-shaped frames including at least one second hole, further comprising at least one screw extending through said at least one first hole and said at least one second hole to thereby retain the chopping board in place.

8. The chopping board device as claimed in claim 7, further comprising at least one spare receiving space for receiving at least one spare chopping board.

9. The chopping board device as claimed in claim 7, further comprising a storage box for receiving spare chopping boards.

10. The chopping board device as claimed in claim 7, wherein the spare chopping boards are in a continuous form and coiled in the storage box, a notch being defined between two of the chopping boards that are adjacent to each other and extending along a width direction of the chopping boards, the notch allowing easy separation of said two chopping boards that are adjacent to each other.

11. The chopping board device as claimed in claim 10, wherein the base further comprising a severing means for separating said two chopping boards that are adjacent to each other by means of severing along the notch.

12. The chopping board device as claimed in claim 1, wherein the base comprises an L-shaped frame in each of two sides thereof, a retaining slot being defined between each of the L-shaped frames and an associated one of the sides of the base, thereby allowing insertion of the chopping board into the receiving space along a direction transverse to a longitudinal direction of the base.

13. The chopping board device as claimed in claim 12, wherein the chopping board comprises at least one first hole in each of two ends thereof, each of the L-shaped frames including at least one second hole, further comprising at least one screw extending through said at least one first hole and said at least one second hole to thereby retain the chopping board in place.

14. The chopping board device as claimed in claim 13, further comprising at least one spare receiving space for receiving at least one spare chopping board.

15. The chopping board device as claimed in claim 13, further comprising a storage box for receiving spare chopping boards.

16. The chopping board device as claimed in claim 13, wherein the spare chopping boards are in a continuous form and coiled in the storage box, a notch being defined between two of the chopping boards that are adjacent to each other and extending along a width direction of the chopping boards, the notch allowing easy separation of said two chopping boards that are adjacent to each other.

17. The chopping board device as claimed in claim 16, wherein the base further comprising a severing means for separating said two chopping boards that are adjacent to each other by means of severing along the notch.

18. The chopping board device as claimed in claim 1, further comprising a frame that is integrally formed on at least one of the sides of the base, a retaining slot being defined between said at least one of the sides of the base and the frame and forming a portion of the receiving space, the chopping board being insertable into the receiving space via the retaining slot, the frame having an opening communicated with the retaining slot, two lugs being configured on the frame and located on both sides of the opening, a lever having an end pivotally received between the lugs, the end of the lever having an eccentric hole and being shaped that the chopping board is retained by the end of the lever when the lever is in a first position and that the chopping board is not retained by the end of the lever when the lever is in a second position.

19. The chopping board device as claimed in claim 18, further comprising at least one spare receiving space for receiving at least one spare chopping board.

20. The chopping board device as claimed in claim 18, further comprising a storage box for receiving spare chopping boards.
